(19) United States
(12) Patent Application Publication
(10) Pub. No.: US 2008/0197077 A1
(43) Pub. Date: Aug. 21, 2008

(54) Low pressure drinking water purifier

(76) Inventors: John S. Swartley, Fairfield, CT (US); Bradley C. Palmer, Old Greenwich, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/011,473

(22) Filed: Jan. 25, 2008

Related U.S. Application Data
(60) Provisional application No. 60/897,633, filed on Jan. 26, 2007.

(51) Int. Cl. B01D 61/14; B01D 21/30; C02F 1/00

(52) U.S. Cl. 210/650; 210/137; 210/741

(57) ABSTRACT

An inexpensive device for removing microorganisms from drinking water includes an Ultrafiltration membrane filter equipped with a pressure regulating mechanism to supply purified water to a suitable low-pressure reservoir equipped with a bi-directional hydrophobic membrane vent filter having a 0.01-0.05-micron pore size. The purified water may be supplied to the storage reservoir at a static pressure in the range of 1 to 8 pounds per square inch.

### CROSS REFERENCE TO RELATED APPLICATIONS

This application claims the benefit of U.S. Provisional Application No. 60/897,633, filed Jan. 26, 2007, which is hereby incorporated by reference in its entirety.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application, and is not admitted to be prior art by inclusion in this section.

The present disclosure relates to a device for purifying drinking water, and more specifically for purifying drinking water to meet the standards of the United States Environmental Protection Agency's (USEPA) Guide Standard and Protocol for Testing Microbiological Water Purifiers (OPP Task Force Report, 1987).

It is known to use suitable hydrophilic Ultrafiltration (UF) membranes with pore sizes ranging from 0.01-0.05 microns to remove bacteria and viruses from water. A filter composed of such UF membranes (a UF filter) installed at the outlet of a water supply line can produce water that meets the requirements for certification as a microbiological purifier. Any device to treat water that makes purification health claims must be certified as a “purifier’ and the device must remove or deactivate 99.9999% of bacteria and 99.99% of viruses in accordance with the USEPA's Guide Standard and Protocol. The water discharged from the purifier device is tested for compliance with this standard after being challenged with a known amount of bacteria and viruses under controlled conditions that simulate the intended use.

Commercially available UF membrane filters, designed for residential or light commercial applications, are commonly used to treat drinking water. Two types of UF filters are available for this use. In one version, membranes are arranged in a “cross flow” arrangement where untreated water flows along side and across the membrane. A portion of this water passes into and through the membrane and is collected as purified water while the rest of the untreated water is directed to a drain. A second available type of UF filter arranges the membrane in a “dead end” configuration. Dead end filters contain hollow fiber membranes. Individual membrane fibers are sealed at one end and open at the other. Water enters a filter housing containing a dead end membrane cartridge and penetrates the hollow fiber from the outside. Water being purified travels to the hollow center of the fiber. The open end of the hollow fiber membrane connects with the outlet of the filter housing so that only treated water can leave the housing. Connected to the source water line at normal utility supplied water pressure (20-45 psi), these dead end UF filter cartridges in a typical 10-inch by 2½-inch housing, supply purified water at flow rates as slow as 1-1.5 liters per minute. At this rate, it would take 10-18 seconds or more to directly fill an 8 oz. glass compared with 2-3 seconds at normal faucet flow rates (3-5 gallons per minute).

For faster flows of purified water, it is common for such commercially available UF membrane filters to be used in conjunction with various types of pressurized storage vessels. These pressure vessels are equipped with an expandable bladder for storing the purified water. As purified water is supplied at line pressure of 20-45 psi or higher to the bladder, the bladder expands to fill the available space in the storage vessel. For most commonly available storage vessels, the bladder merely compresses the sealed air in the vessel. When the user opens the outlet faucet, the air pressure built up in the vessel then squeezes the bladder to dispense water. Bladder storage of purified water from a UF filter requires specialized pressure vessels that can be difficult to clean. Microbiological testing of these vessels has shown problems with bacterial contamination over time.

An alternative to pressurized storage is the use of a collection container open to the atmosphere for storage of the treated water. It is known to collect treated water from the UF filter in a suitable container equipped with flow controls, float valves or overflow drains to avoid overfilling the container. As needed this water is then dispensed through a valve or spigot at the bottom of the container and the container is refilled once the level control mechanism opens the appropriate supply valve.

A suitable container for treated purified water must be open to the atmosphere during the venting that occurs on filling and dispensing to avoid creating a vacuum or overpressure situation. This exchange of air during venting is a key source of recontamination of the treated water by airborne microorganisms. To maintain the level of purification required by the EPA certification, the stored purified water must be protected from recontamination.

What is needed in the art is a simple reliable way of supplying purified water from any water source using commercially available components and filters, and storing the purified water in a protected storage container that automatically fills and refills without any separate control mechanisms.

### SUMMARY OF THE INVENTION

The above discussed and other drawbacks and deficiencies of the prior art are overcome or alleviated by the presently described water purification system. The system comprises one or more pressure regulating devices, inline water treatment housings for pretreatment filters (if needed) and a UF filter containing dead end membrane fibers with a 0.01-0.05 micron rating, a low-pressure reservoir, such as a normal 5-gallon plastic water bottle, that is equipped with a bi-directional hydrophobic membrane vent filter with a specific 0.01-0.05 micron pore size, and a suitable dispensing system. Purified water from the UF filter is supplied to the bi-directional hydrophobic membrane vent filter protected container until the filled container reaches a static pressure in the range of 1-8 PSI.

Operating a dead end Point of Use (POU) ultrafiltration membrane filter with a 0.02-micron pore size at low pressure (at a range of 10-20 PSI and typically less than 15 PSI) insures that the membrane filter can reliably remove 99.9999% of bacteria and 99.99% of viruses from untreated water in compliance with, the EPA Guide Standard and Protocol. Moreover, operating at this low pressure increases the useful service life of the membrane as trapped microorganisms are not forcibly lodged into the membrane pores but typically remain in suspension within the membrane. The use of a dead end membrane filter allows the device to operate without the need for a separate drain and there is no wasted water.

Operating the UF membrane filter at low pressures means that the output flow of a typical commercially available UF membrane filter cartridge (approximately 10 inches in length by 1.3 inches in diameter) will only supply about 0.5 ounces of purified water per second over its expected service life. At this slow flow an 8 oz glass would take about 16-18 seconds to fill, which would be unacceptable to most consumers. Therefore, a storage container is required to accumulate a practical amount of purified water for convenient rapid dispensing. Supplying water from the UF filter to the storage container at a static pressure range from 1-8 PSI means that inexpensive containers (such as 5 gallon water bottles that cannot withstand static pressures higher than approximately 10 psi) and simple plastic dispensers can be used without risk of rupturing the container. Such simple storage containers can then be replaced after an appropriate service cycle or easily removed for cleaning.

Any suitable low-pressure container for storing purified water must be open to the atmosphere during the venting that occurs on filling and dispensing to avoid creating a vacuum that could collapse the container or an overpressure situation that could rupture the container. This exchange of air during venting is a source of microbial recontamination of the stored purified water by various types of airborne microorganisms in the immediate environment. To maintain the level of purification required by the EPA certification, the stored water must be protected from recontamination. A bi-directional hydrophobic membrane with a suitable pore size (0.01 to 0.05 microns) is an effective means to block airborne microorganisms when used as a venting device. These membranes allow air to pass freely in both directions while blocking airborne microorganisms. These membranes are used routinely in critical pharmaceutical processes to protect stored fluids. In these applications, storage vessels must be fitted with overflow control devices based on fluid level controls that stop fluids from reaching the vent. Even though the vent membranes are hydrophobic, they are typically not a reliable method of blocking water leakage when acting as an overflow device.

Currently available hydrophobic vent filters used in pharmaceutical fluid storage applications are not used to control fluid overflow. For example, the Hydrophobic PTFE Media Vent Capsule Filter Catalog Number FCVPT06S1 from Siemens Water Technologies (catalog page 59) is composed of a pleated hydrophobic PTFE filter membrane rated at 0.01 um (micron) absolute and rated for a maximum pressure differential of 65 PSI. The catalog sheet, however, has the following cautionary NOTE: These filter cartridges should not be used as a combination air vent/water overflow device. Therefore, it has been specifically recognized that hydrophobic vent filters should not generally be used as combination air vent/water overflow devices.

For protecting purified water storage in accordance with an aspect of the present invention, it may be useful to take advantage of both the venting feature of these bi-directional hydrophobic membranes as well as their inherent water blocking features. The prohibition about using this type of bi-directional hydrophobic membrane as an overflow control method is a function of both the static pressure in the filled container and repeated wetting of the membrane surface. It is generally understood that hydrophobic membranes may not be permanently hydrophobic, and in time, regardless of pressure, water molecules in contact with the membrane will penetrate the membrane and degrade both its water blocking performance and its venting performance. However, in relation to embodiments of the present invention it has been discovered that at low storage container static pressures (typically less than 10 psi), the hydrophobic membrane will not allow water to leak from the container, and will allow air to pass in and out for proper venting over thousands of repeated wettings of the membrane surface. Thus, when the container is full, no water can pass the membrane and flow stops automatically. Flow resumes when water is dispensed and the static pressure in the container is relieved. Use of this membrane for both venting and overflow control avoids the need for separate flow control mechanisms and/or drains.

The use of ultrafiltration combined with low-pressure bi-directional hydrophobic membrane vent storage control represents a simple reliable way of supplying and storing purified water from any source. Filling and refilling the storage container requires no separate controls. The device is both economical to manufacture and reliable to operate.

Testing indicates that venting and overflow protection performance of the bi-directional hydrophobic membrane will be acceptable for over six to twelve months of continuous use when operated under the specified static pressure conditions. Periodic replacement of the treatment cartridges and the bi-directional hydrophobic membrane would be required based on supply water quality and ambient air quality at the specific point of use.

In accordance with a first aspect of the invention, a water purification system is provided that may include a pressure regulating device configured to output water at a pressure substantially between one and eight pounds per square inch, a filter housing coupled to the pressure regulating device, a storage reservoir coupled to the pressure regulating device, and configured to receive water from the filter housing, and a vent filter disposed substantially in operational communication with the storage reservoir.

In accordance with the first aspect of the invention, the vent filter may include at least one bi-directional hydrophobic membrane.

In accordance with the first aspect of the invention, the vent filter may be configured, to pass air into and out of the storage reservoir.

In accordance with the first aspect of the invention, the vent filter may have a pore size substantially between 0.01 and 0.05 microns.

In accordance with the first aspect of the invention, the filter housing may be configured to receive a filter element.

In accordance with the first aspect of the invention, the filter element may be an ultrafiltration membrane filter.

In accordance with the first aspect of the invention, the ultrafiltration membrane filter pore size may be substantially between 0.01 and 0.05 microns.

In accordance with the first aspect of the invention, the ultrafiltration membrane filter may include a hydrophilic capillary microfiltration tubular membrane.

In accordance with the first aspect of the invention, the filter element may be configured to remove particles larger than 0.15 microns from water.

In accordance with the first aspect of the invention, the water purification system may also include a water supply inlet configured to detachably receive a water supply line.

In accordance with the first aspect of the invention, the storage reservoir may be detachably coupled to the pressure regulating device.

In accordance with the first aspect of the invention, the pressure regulating device may include a water pressure regulator.

In accordance with the first aspect of the invention, the pressure regulating device may include a water storage container that includes a first opening and a second opening, the second opening is configured to direct a flow of water through the filter housing to the storage reservoir.

In accordance with the first aspect of the invention, the vent filter is disposed substantially within an aperture of the storage reservoir.

In accordance with a second aspect of the invention, a method is provided that may include providing a pressure regulating device configured to output water at a pressure substantially between 1 and 8 pounds per square inch, providing a filter housing configured to couple to the pressure regulating device, providing a storage reservoir configured to couple to the pressure regulating device, and configured to receive water from the filter housing, and providing a vent filter disposed substantially in operational communication with the storage reservoir.

In accordance with the second aspect of the invention, the vent filter may include at least one bi-directional hydrophobic membrane.

In accordance with the second aspect of the invention, the vent filter may be configured to pass air into and out of the storage reservoir.

In accordance with the second aspect of the invention, the vent filter may have a pore size substantially between 0.01 and 0.05 microns.

In accordance with a third aspect of the invention, a method is provided that may include connecting a storage reservoir that includes a vent filter to an assembly that includes an ultrafiltration filter element, and providing an amount of water from a water supply source through the ultrafiltration filter element for deposition into the storage reservoir.

In accordance with the third aspect of the invention, the method may also include depositing the amount of water into the storage reservoir from the ultrafiltration filter element.

In accordance with the third aspect of the invention, the vent filter may include at least one bi-directional hydrophobic membrane.

In accordance with the third aspect of the invention, the vent filter may be configured to pass air into and out of the storage reservoir.

In accordance with the third aspect of the invention, the vent filter may have a pore size substantially between 0.01 and 0.05 microns.

In accordance with fourth aspect of the invention, a water purification system is provided that includes means for outputting water at a pressure substantially between 1 and 8 pounds per square inch, means for housing a filter element, the means for housing are coupled to the means for outputting water, means for storing an amount of water, the means for storing are coupled to the means for outputting water, and means for filtering air vented into and out of the means for storing.

In accordance with a fifth aspect of the invention, a water purification system is provided that may include a first pressure regulating device configured to output water at a pressure substantially between 10 and 20 pounds per square inch, a second pressure regulating device configured to output water at a pressure substantially between 1 and 8 pounds per square inch, at least one filtration element positioned between the first pressure regulating device and the second pressure regulating device, an ultrafiltration membrane filter positioned between the first pressure regulating device and the second pressure regulating device, a storage reservoir coupled to the second pressure regulating device, and configured to receive water output by at least the second pressure regulating device, and a bi-directional hydrophobic membrane vent filter disposed substantially within an opening of the storage reservoir.

The above discussed and other features and advantages of the present invention will be appreciated and understood by those skilled in the art from the following detailed descriptions and drawings.

### BRIEF DESCRIPTION OF THE DRAWINGS

Referring now to the exemplary drawings wherein like elements are numbered alike in the several FIGURES:

FIG. 1 is a schematic view of an exemplary embodiment of the low pressure water purifier system according to the present invention;

FIG. 2 is a schematic view similar to FIG. 1 with various additional pressure indicators, flow controls indicators and cycle timing devices used to test the venting and overflow protection performance of bi-directional hydrophobic membranes under simulated long-term service conditions.

FIG. 3 is a schematic view of an exemplary embodiment of the present invention using temporary water supply connections and a detachable bi-directional hydrophobic membrane vent protected reservoir;

FIG. 4 is a schematic view of another embodiment that uses gravity as the pressure regulating method to control the flow of purified water to an airtight reservoir equipped with a bi-directional hydrophobic membrane vent filter;

FIG. 5 is a chart showing dispensing cycle testing of an embodiment of the present invention at 5 pounds per square inch; and

FIG. 6 is a chart showing dispensing cycle testing of an embodiment of the invention at 10 pounds per square inch.

### DETAILED DESCRIPTION OF THE INVENTION

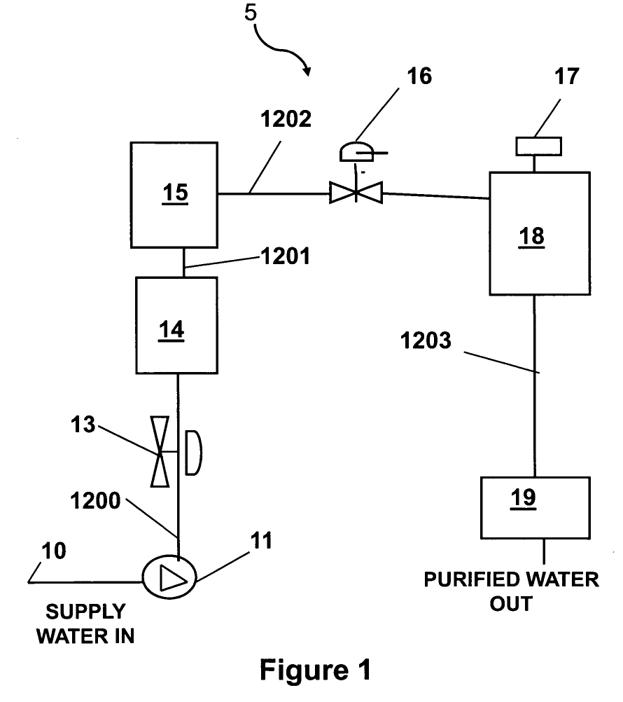

Referring now to FIG. 1, an exemplary embodiment of a low pressure drinking water purifier device, generally indicated by the numeral 5, according to the present invention is shown. Water from any available supply line 10 is connected to the water purifier device through a supply water backflow check valve 11. The supply water backflow check valve 11 functions to prevent flow of any water from the water purifier device back into the supply line 10. The supply water backflow check valve 11 may be configured to meet the ANSI/NSF-61 standard related to health effects of drinking water system components, and may be capable of withstanding a maximum pressure of 75 psi at 33 to 160 degrees Fahrenheit. For example, the supply water backflow check valve 1 may be a copper NSF-certified backflow prevention valve item number 9117k31 from MCMASTER-CARR® or equivalent.

From supply water backflow check valve 11, water is supplied by tubing 1200, for example ¼ inch OD High Density Polyethylene or an equivalent tubing, to a supply pressure regulator 13. The supply pressure regulator 13 is configured to set and maintain the water pressure when inlet pressure from the supply line 10 exceeds the discharge set pressure. The supply pressure regulator 13 may be constructed from a modified polyphenylene oxide, e.g. NORYL® resin, body with Buna-N diaphragm and seals with a stainless steel stem, for example WATTS® model P60 regulator item number 0354556 or equivalent. The supply pressure regulator 13 may have a range from 0 to 125 psi. From supply pressure regulator 13, water is directed by tubing 1200 to prefilter housing 14, which provides support for and seals a replaceable pre-filtration element (not shown) into the water purifier system. In an exemplary embodiment of the invention, the prefilter housing 14 may be made from polypropylene, configured to accommodate a 2½ inch by 10 inch prefilter filter cartridge, and contain ⅜ NPTF connections. For example, the prefilter housing 14 may be GENERAL ELECTRIC® item number GX1S01C or equivalent. The prefilter cartridge is designed for removing particles larger than 0.15 microns, for example bacteria. The cartridge may contain hydrophilic capillary micro-filtration tubular membranes. The cartridge may be approximately 1.3 inches in diameter and 10 inches long. For example, the prefilter cartridge may be item number CE13-10.1501 MF from PRIME WATER INTERNATIONAL or various other suitable prefiltration media.

From prefilter housing 14, water is directed by tubing 1201 to the ultra filtration (UF) filter housing 15, which contains a membrane UF cartridge (not shown). Tubing 1201 may be of similar type and construction as tubing 1200. The UF filter housing 15 provides support for and seals the ultra filtration element, i.e. the membrane UF cartridge, into the water purifier system. The UF filter housing 15 may have a similar construction as the prefilter housing 14 discussed above, but it is understood that the UF filter housing 15 may also have any other suitable construction. The membrane UF cartridge filters the pre-filtered water removing particles above 0.02 microns, including viruses, and renders potable water into purified water. The membrane UF cartridge may contain hydrophilic capillary micro-filtration tubular membranes with a 0.02 absolute micron rating. For example, the membrane UF cartridge may be item number CE13-10.02.01 UF from PRIME WATER INERNATIONAL or another suitable UF filter membrane. The UF cartridge may also be a dead end UF membrane cartridge with a pore size range between 0.01 and 0.05 microns.

Tubing 1202 then directs purified water from the UF filter housing 15 to purified water reservoir pressure regulator 16, which is configured to set and maintain purified water pressure to the water storage reservoir 18. For example, the purified water reservoir pressure regulator 16 is configured to maintain the water pressure supplied to the water storage reservoir 18 at a static pressure range between 1 to 8 pounds per square inch (PSI). Purified water reservoir pressure regulator 16 may be any suitable water pressure regulator, and may be of the same type and construction as the supply pressure regulator 13. From purified water reservoir pressure regulator 16, water is directed to the water storage reservoir 18, which may be a 5-gallon polycarbonate or polyethylene plastic water bottle, other another suitable plastic or other type of container. Purified water enters the water storage reservoir 18 through a suitable airtight connection at any convenient entry point (not shown). The water storage reservoir 18 stores purified water for intermittent dispensing, and purified water may be continuously replenished at the system flow rate until the water storage reservoir 18 is at capacity.

At least one bi-directional hydrophobic membrane vent filter assembly 17 is installed in water storage reservoir 18 through a suitable airtight connection (not shown) in the top of the water storage reservoir 18. It is also understood that the vent filter assembly 17 may be installed in operational communication with the water storage reservoir 18. The vent filter assembly 17 acts to allow venting of air into and out of the water storage reservoir 18 when water is placed into and drawn out of the water storage reservoir 18. Therefore, it is understood that the vent filter assembly 17 may be installed at any location of the low pressure drinking water purifier 5 that allows venting of air into and out of the water storage reservoir 18. The vent filter assembly 17 includes a membrane filter (not shown) and membrane filter holders. The membrane filter filters and balances atmospheric air being drawn into and discharged from the water reservoir during the purified water withdrawal and subsequent re-filling cycle. Particles larger than 0.05 microns are removed from the air stream by the membrane filter of the vent filter assembly 17. In an exemplary embodiment, the membrane filter is hydrophobic, and therefore the membrane filter will not allow water to penetrate its surface, and the membrane filter can be used as a valve to shut off incoming water to the system when the water storage reservoir 18 is completely filed. The membrane filter may be laminated PVDF membrane and polypropylene mesh 0.05 absolute retention rated, and may be 47 millimeters in diameter. Two or more membrane filters may be connected in parallel or series. The membrane filters may be those such as part number NCS 11061 from W. L. GORE & ASSOCIATES. The vent filter assembly 17 also includes at least one membrane filter holder (not shown) that provides support and seals the membrane filters installed above the highest elevation of the water storage reservoir 18. The membrane filter holder may have a polypropylene body with silicone seals and configured to hold 47 mm diameter membrane filters. For example the membrane filter holder may be a membrane filter holder such as part number K-06623-22 from COLE-PARMER®.

Tubing 1203 directs water from water storage reservoir 18 to dispensing valve 19, or in an alternative embodiment of the invention the dispensing valve 19 can also be installed directly into the bottom of the water storage reservoir 18 instead of being connected by tubing 1203. The dispensing valve 19 is configured to operate to release water from the water storage reservoir 18. The dispensing valve 19 may be made from food grade polyproplylene with EPDM seals, and may be able to sustain a maximum pressure of 150 psi at 33 to 150 degrees Fahrenheit, for example item number 4503K23 from MCMASTER-CARR®, or an equivalent dispensing valve. The dispensing valve 19 may be positioned higher than the bottom of the water storage reservoir 18 so that unfiltered air cannot enter the water storage reservoir 18 in the event that the dispensing rate of water from the water storage reservoir 18 exceeds the refilling rate of water entering the water storage reservoir 18.

The position of the dispensing valve 19 creates a trap so that the last amount of water does not leave the water storage reservoir 18. This amount of water provides an airtight seal so that air does not enter through the open dispensing valve 19.

In an exemplary embodiment of the present invention shown in FIG. 1, the low pressure drinking water purifier may use the dead end UF membrane cartridge (not shown) with a pore size range from 0.01-0.05 microns to slowly fill the water storage reservoir 18, such as a normal 5-gallon plastic water bottle, or other suitable inexpensive low pressure reservoir, that is equipped with a suitable number of vent filter assemblies 17 (from 1-5) each containing a 47 mm diameter bi-directional hydrophobic flat membrane disc with a 0.01-0.05-micron (typically 0.05 micron) rating. The vent filter assemblies 17 may be in operational communication with the water storage reservoir 19 either in parallel or in series. Water to be purified is pretreated as necessary depending of source water quality, and supplied to the UF membrane filter at a pressure in the range of 8-20 PSI. Purified water from the membrane filter is supplied to the water storage reservoir 18 at a static pressure range of from 1-8 PSI. This static pressure range is well below the operating pressure rating of bi-directional hydrophobic membrane vent filters (approximately 65 PSI) and well below the pressure rating of a typical inexpensive plastic reservoir (5-gallon plastic water bottles cannot be safely pressurized above 10 PSI).

Storing and dispensing purified water from a reservoir that is open to the atmosphere at the top requires allowing air to enter and leave the reservoir as the level of water in the reservoir changes during normal operation of the discharge valve. Unless this air is purified, it will contaminate the stored purified water and prevent the device from achieving purifier certification in accordance with USEPA's Guide Standard and Protocol of the dispensed purified water. The bi-directional hydrophobic membrane vent filter with a 0.01-0.05-micron pore size will block air borne bacteria and viruses from entering the reservoir under the appropriate operating conditions.

Using a bi-directional hydrophobic membrane with this pore size as the vent filter generally allows air to pass freely but this air venting performance will be degraded over time if water is allowed to stay in contact with the membrane surface. Moreover, water will begin to leak from the wetted bi-directional hydrophobic membrane vent filters at static pressures well below the bi-directional hydrophobic membrane vent filters' specified maximum operating pressure of 65 PSI.

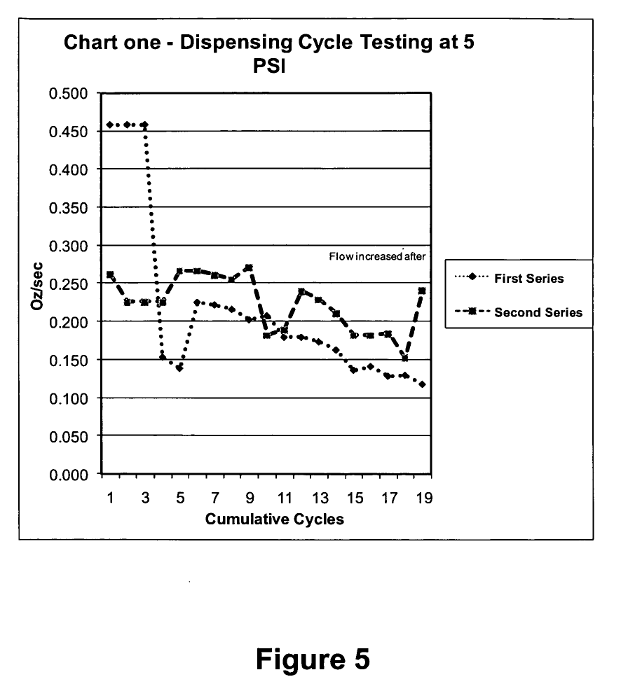

When dispensing water, the amount of air passing in and out of the vent filter controls the water dispensing rate for any size dispensing line and valve combination. Two series of tests at 5-PSI static container pressure using the test apparatus described in FIG. 5 below show continued declines in the water dispensing rate over multiple cycles of repeated wetting of the bi-directional hydrophobic membrane vent filters. While the membrane vent filters' venting performance declined, the ability of the bi-directional hydrophobic membrane vent filters to restrict water flow was maintained and no water leaked from the container at the 5-PSI static pressure limit.

Similar declines in venting performance were observed when new bi-directional hydrophobic membrane vent filter discs were repeatedly wetted at 10-PSI static pressure. Following a brief container static pressure surge to 14.5 PSI, water leaked from the bi-directional hydrophobic membrane vent filters. After drying, vent performance was restored and testing was continued. Two of three installed bi-directional hydrophobic membrane vent filter discs failed to block water the next day at 10 PSI. One bi-directional hydrophobic membrane vent filter disc continued to stay dry at 10 PSI and its venting performance declined through the end of the test as expected.

Referring again to FIG. 1, in an exemplary embodiment, the water storage reservoir 18 can be an empty standard 5-gallon polycarbonate or PET water bottle installed neck down in a dispensing system that contains a dispensing valve 19 such as a standard water cooler (not shown). The neck of the water bottle is sealed to the cooler using airtight seals (not shown). Two holes (not shown) are drilled at the top of the upside down bottle to accept both the bi-directional hydrophobic membrane vent filter assembly 17 and tubing 1202 from a suitable UF membrane filter housing 15 coupled to the water reservoir pressure regulator 16. Water is supplied from any available source line 10 at normal utility pressure (20-45 PSI) and is sent to supply pressure regulator 13. From supply pressure regulator 13, water is then sent by tubing 1200 to the prefilter housing 14 and the UF filter housing 15 at reduced pressure (from 10-20 PSI). Water from the UF filter housing 15 is further pressure reduced by water reservoir pressure regulator 16 and slowly fills the 5-gal water bottle making up the water storage reservoir 18, pushing air out of the vent filter assembly 17 until the static pressure in the filled water storage reservoir 18 reaches 1-8 PSI. When the water level in the water storage reservoir 18 reaches the bottom of the membrane installed in vent filter assembly 17 there is no more air in the water storage reservoir 18. Since water cannot pass through the bi-directional hydrophobic membrane in vent filter assembly 17, pressure builds up in the water storage reservoir 18 until this static bottle pressure equals the pressure supplied by water reservoir pressure regulator 16 (1-8 PSI). At that point, there is no more water flow from the UF filter housing 15 through the water reservoir pressure regulator 16. The opening of the dispensing valve 19 coupled to the water storage reservoir 18 dispenses water. Flow begins from the UF filter housing 15 once the level of the water falls below the bottom of the bi-directional hydrophobic membrane surface in the vent filter assembly 17 and air enters the water storage reservoir 18 to relieve the static pressure build-up.

The artisan skilled in the art would recognize that, the water purifier device 5 can be based on other water bottles sizes that are removably sealed to other dispensers. For example, a small 2-gallon water bottle removably sealed to a countertop dispenser is another practical exemplary application. In another alternative, a ball check device is made part of the vent filter assembly 17 to help reduce the amount water reaching the bi-directional hydrophobic membrane surface. In another alternative, a pleated membrane or a hollow fiber membrane with the appropriate pore size is used within the vent filter assembly 17 instead of flat discs. Depending on overall water quality, various pretreatment devices can be installed ahead or following of the UF filter housing 15 including sediment filters, particulate filters, carbon filters, ultra violet devices and reverse osmosis filters, either singly or in combination. These pretreatment devices (not shown) may be included in the prefilter housing 14. It is understood that there may be more than one prefilter housing 14 depending upon the number of pretreatment devices needed for a particular application. However, only one prefilter housing 14 is shown in FIG. 1 for purposes of simplicity.

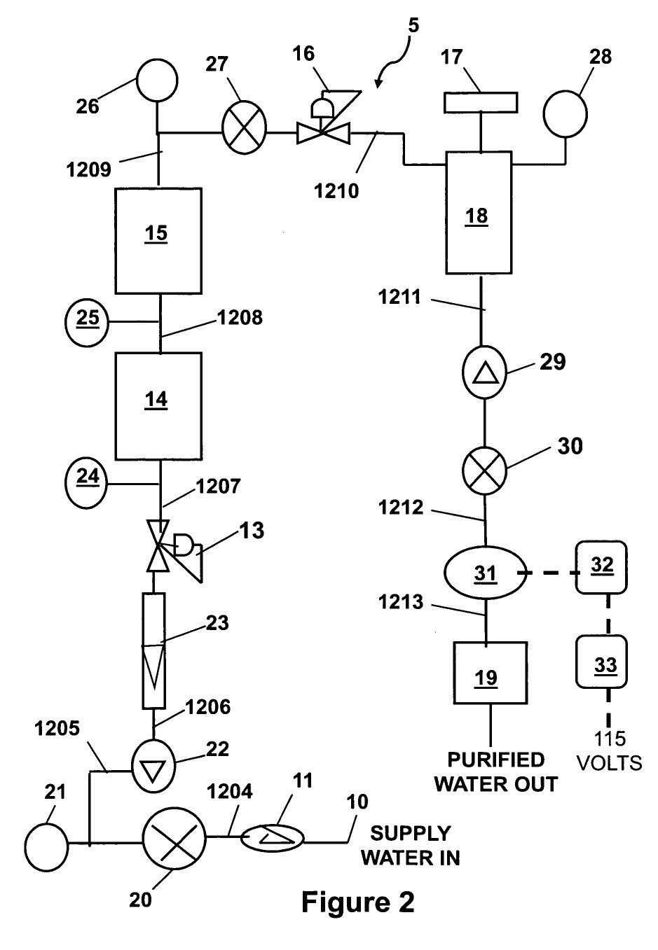

Referring now to FIG. 2, a schematic representation of the presently disclosed low pressure drinking water purifier device 5 that was designed and constructed for testing the appropriate operating conditions of the device is shown. Items shown in FIG. 2 with like references numerals as items shown in FIG. 1 correspond to those items of FIG. 1. Water from any available supply line 10 is connected to the device through a supply water backflow check valve 11. From supply water backflow check valve 11, water is supplied by tubing 1204 to supply shut-off valve 20, which is configured to allow manual turning of water on or off. Supply shut-off valve 20 may be made from food grade polypropylene with EPDM seals, for example item number 450K23 from MCMASTER-CARR® or equivalent. Water can then be supplied by tubing 1205 to pressure indicator 21, which indicates the pressure of the potable water supplied to the system, and may be item number 4089K64 from MCMASTER-CARR® or equivalent pressure indicator, as well as to supply flow control valve 22, which may be item number 7781K41 from MCMASTER-CARR® or equivalent control valve. Water may then be provided by tubing 1206 to supply flow indicator 23, which may be item number 5147544-00 from COLE PALMER® or an equivalent flow indicator.

From supply flow indicator 23, tubing 1207 directs water to pressure regulator 13. From supply pressure regulator 13, water is directed by tubing 1207 to pre-filter inlet pressure indicator 24, which may be item number 4089K64 from MCMASTER-CARR® or an equivalent pressure indicator as well as to prefilter housing 14, which contains a suitable prefilter cartridge (not shown). From prefilter housing 14, water is directed by tubing 1208 to pre-filter outlet/ultrafilter inlet pressure indicator 25, which may be of similar composition as inlet pressure indicator 24, as well as to the Ultra filtration (UF) filter housing 15, which contains a membrane UF cartridge (not shown). Tubing 1209 directs purified water from the UF filter housing 15 to ultrafilter outlet pressure indicator 26, which may be of similar composition as inlet pressure indicator 24, as well as to purified water reservoir shut-off valve 27, which may be of similar composition as supply shut-off valve 20. From shut-off valve 27, tubing 1210 directs the water to reservoir pressure regulator 16. From purified water reservoir pressure regulator 16, water is directed to water storage reservoir 18.

Purified water enters the water storage reservoir 18 through a suitable airtight connection at any convenient entry point (not shown). In this exemplary embodiment of the invention, vent filter assembly 17 contains three membrane holders (not shown) and three replaceable hydrophobic flat membranes discs (not shown) are installed into the top of the water storage reservoir 18 through a suitable airtight connection (not shown). Reservoir pressure indicator 28, which may be item number 3941K74 from MCMASTER-CARR®, is installed into the top of the water storage reservoir 18 by a suitable airtight connector. From water storage reservoir 18 tubing 1211 directs water to dispensing flow control valve 29, which may be item number 100-202 from B&K® Industries, and to dispensing shutoff valve 30, which may be a dispensing shutoff valve such as item number M-100-/38 from American Value. From shutoff valve 30, tubing 1212 directs water to normally closed solenoid cycle control valve 31, for example item number Q212317-1351B-120VAC from KIP, Inc., which is controlled by percentage ON/OFF cycle control timer 32, which may be a control timer such as PARAGON® Electrical Products item number EJW. Connected to cycle timer 32 is on cycle elapsed time indicator 33, which may be an elapsed time indicator such as Ingram Products, Inc. item number HRM9230ACRSS that records, displays and accumulates the hours that the solenoid 31 is energized. From solenoid 31, tubing 1213 directs water to dispensing valve 19.

The test apparatus shown in FIG. 2 is designed to monitor the performance of the bi-directional hydrophobic membrane vent filters used in the vent filter assembly 17 during repeated service cycles of the low pressure drinking water purifier-device. The cycles were designed to simulate the type of actual dispensing and refilling that involves repeated wetting of the membrane surface. Since this testing used various water pressures, water storage reservoir 18 was not a 5 gal plastic water bottle, but a specially constructed pressure vessel to avoid potential ruptures and leaks. For this testing, water storage reservoir 18 consisted of an 8″ PVC pipe with solvent welded pipe caps having appropriate threaded connections to accommodate process valves (not shown), the vent filter assembly 17, a pressure indicator 26 and a ⅜″ dispensing valve 19. The vessel had approximately 5 gallons of water storage capacity.

In this exemplary embodiment of the invention shown in FIG. 2 used for testing, vent filter assembly 17 consisted of three membrane discs in three membrane holders connected in parallel to water storage reservoir 18 by ¼ tubing and individual shutoff valves. The operating characteristics of this vent filter assembly 17 were first determined as follows. Untreated water was supplied to the test apparatus at from 38-44 PSI through the supply line 10. This supply water pressure is reduced to 15-PSI at the inlet of the UF filter housing 15 by the supply pressure regulator 13. The pressure of purified water from the UF filter housing 15 is reduced by the water reservoir pressure regulator 16 so that the static pressure in the filled water storage reservoir 18 is 5-PSI. Water was dispensed from water storage reservoir 18 first with vent filter assembly 17 removed entirely, then with vent filter assembly 17 closed, then with one open membrane vent, then with two open membrane vents, and finally with three open membrane vents. Based on this test, it was determined that the use of three membrane holders in parallel with three flat membrane discs venting to the atmosphere best replicated the dispensing rate of this reservoir when the vent filter assembly 17 was removed and the water storage reservoir 18 was completely open to the atmosphere. Subsequent service cycle testing used three membrane holders with three flat membrane discs installed.

The service cycle testing was conducted as follows. Starting with a filled water storage reservoir 18 at 5-PSI static pressure, the cycle control timer opened the solenoid valve 31 for twelve seconds to allow water to exit the water storage reservoir 18 through the open dispensing valve 19. After twelve seconds, the solenoid valve 31 closed to stop water from exiting the water storage reservoir 18. The solenoid valve 31 the remained closed for 108 seconds. During this 120-second cycle, the water storage reservoir 18 was being refilled and after approximately 75-80 seconds the water storage reservoir 18 was full again and the reservoir static pressure returned to 5-PSI. With a full water storage reservoir, the design of the membrane holder assembly allowed water to reach the membrane surface.

Two series of tests were conducted with the filled water storage reservoir 18 at 5-PSI static pressure. New membrane discs were installed for Series 1 and removed at the end of the test period. Another set of three new membrane discs were then installed for Series 2. The measured dispensing rate of these two membrane sets for this test apparatus over the cumulative cycles of dispensing and refilling are included in Table One and shown in the chart of FIG. 5.

TABLE 1
Dispensing Test - 12 second Dispensing - 108 second Refilling per cycle

| Series One | | | Series Two | | |
|---|---|---|---|---|---|
| 5 PSI Static Container Pressure | | | 5 PSI Static Container Pressure | | |
| Chart Point | Oz/Sec | Cycles | Chart Point | Oz/Sec | Cycles |
| 1 | 0.458 | 0 | 1 | 0.262 | 0 |
| 2 | 0.458 | 705 | 2 | 0.225 | 720 |
| 3 | 0.458 | 1,425 | 3 | 0.225 | 1,350 |
| 4 | 0.154 | 2,127 | 4 | 0.225 | 2,280 |
| 5 | 0.139 | 4,107 | 5 | 0.267 | 3,000 |
| 6 | 0.225 | 4,755 | 6 | 0.267 | 4,398 |
| 7 | 0.222 | 5,265 | 7 | 0.261 | 5,166 |
| 8 | 0.216 | 5,982 | 8 | 0.255 | 5,883 |
| 9 | 0.203 | 6,702 | 9 | 0.271 | 6,687 |
| 10 | 0.208 | 8,916 | 10 | 0.182 | 7,377 |
| 11 | 0.180 | 9,690 | 11 | 0.189 | 9,549 |
| 12 | 0.180 | 10,380 | 12 | 0.240 | 10,203 |
| 13 | 0.174 | 10,860 | 13 | 0.229 | 10,353 |
| 14 | 0.163 | 12,240 | 14 | 0.211 | 11,283 |
| 15 | 0.137 | 13,734 | 15 | 0.182 | 12,693 |
| 16 | 0.142 | 14,451 | 16 | 0.182 | 13,383 |
| 17 | 0.129 | 15,261 | 17 | 0.184 | 14,133 |
| 18 | 0.130 | 15,882 | 18 | 0.152 | 14,883 |
| 19 | 0.119 | 16,662 | 19* | 0.241 | 15,423 |

*Membrane dried

Both Series One and Series Two show similar declines in dispensing rates over the total simulated service life. See FIG. 5. For both Series, dispensing rates declined by about ⅓ after approximately 16,000 cycles. This modest decline would not seriously affect the dispensing performance of the device in actual use. More importantly, over this simulated service life, there was not any leakage of water from the membrane filter assemblies. At the end of Series Two, the water supply was interrupted for approximately one day and the membranes dried out. It appears that once dried out and returned to service, the membrane dispensing performance was virtually restored.

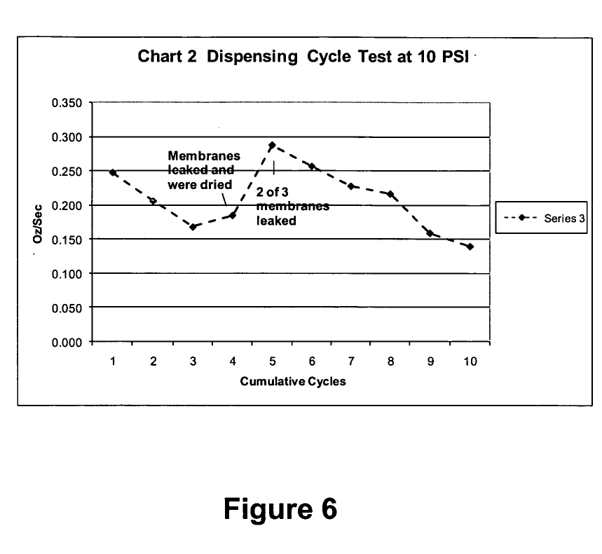

A third test series was conducted with the filled reservoir set at 10-PSI static pressure. All other conditions of the testing were the same including the 12-second dispensing and 108 seconds refilling cycle. The results of this testing are summarized in Table 2 and FIG. 6.

TABLE 2
Dispensing Test - 12 second Dispensing - 108 second Refilling Per Cycle

| | Series Three - 10 PSI Static | |
|---|---|---|
| | Container Pressure | |
| Chart Point | Oz/Sec | Cycles |
| 1 | 0.247 | 840 |
| 2 | 0.206 | 3,060 |
| 3 | 0.168 | 3,810 |
| 4 | 0.185 | 4,980 *leaked and dried |
| 5 | 0.287 | 5,760 *2 of 3 leaked |
| 6 | 0.257 | 7,260 |
| 7 | 0.227 | 8,670 |
| 8 | 0.216 | 11,580 |
| 9 | 0.159 | 14,400 |
| 10 | 0.140 | 16,350 |

Series 3 testing results with the water storage reservoir 18 at 10-PSI static pressure were inconsistent. A new set of membrane discs performed erratically. Due to a brief static pressure increase in the filled reservoir to 14.5-PSI, all three membrane discs leaked. They were removed, dried and reinstalled. After 780 cycles of testing at 10-PSI, two of the three membrane discs leaked and were removed. After closing the two leaking vents, testing continued with a single open vent and a single membrane disc to completion at 16,350 cycles. The single membrane disc showed a typical decrease in dispensing rate over the balance of the testing. While one membrane disc withstood the 110-PSI static pressure without leaking, the failure of two other discs to block water indicates that operating bi-directional hydrophobic membrane vents at 10-PSI static pressure could result in unacceptable water leakage.

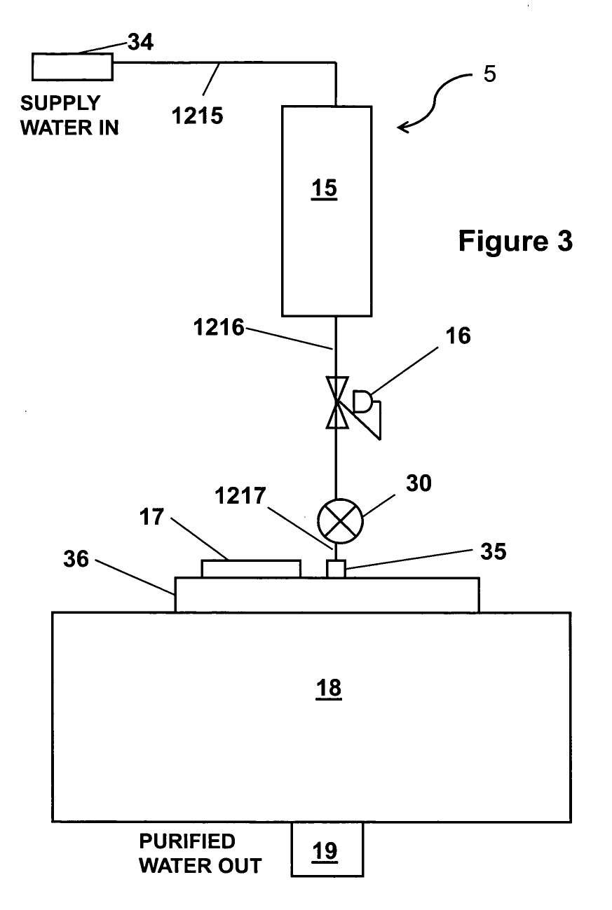

FIG. 3 is a schematic view of another exemplary embodiment using temporary water supply connections 34 and a detachable water storage reservoir 18.

Referring now to FIG. 3, water from any available faucet is supplied to this device through faucet connection assembly 34 which may be a hose barb connector or a commonly available faucet diverter valve. From the faucet connection assembly 34, tubing 1215 directs water to UF filter housing 15, which may contain a combination cartridge consisting of UF membranes with a pore size range from 0.01-0.05 microns and suitable pretreatment media, for example filters capable of removing particles above 0.15 microns, if needed. The UF filter housing may also contain only a cartridge consisting of UF membranes, or only UF membranes. From UF filter housing 15, tubing 1216 directs water to purified water regulator 16 and then to shutoff valve 30. From shutoff valve 30, water is directed by tubing 1217 to a quick disconnect valve 35, which is installed in the removable threaded container cap 36 and directs water into water storage reservoir 18. Removable cap 36 also contains the bi-directional hydrophobic membrane vent filter assembly 17 and provides an airtight closure at the top of purified water storage reservoir 18. Water is dispensed from water storage reservoir 18 by dispensing valve 19.

Referring again to FIG. 3, in an exemplary embodiment, the purified water storage reservoir 18 can be easily detached from the tubing 1217 after closing the purified water shutoff valve 30 and releasing the quick disconnect valve 35. The detached water storage reservoir 18 remains protected from airborne contamination since the only opening to the atmosphere is through vent filter assembly 17. While dispensing water, vent filter assembly 17 allows air to enter the water storage reservoir 18 while blocking any airborne microorganisms. By constructing the water storage reservoir 18 with suitable dimensions, once detached, it can be placed in a refrigerator for convenient dispensing of chilled purified water. The water storage reservoir 18 can also be kept in any other convenient location while the detachable treatment components are stored between uses. Removable threaded container cap 36 can be removed once the performance of its bi-directional hydrophobic membrane vent filter is no longer acceptable.

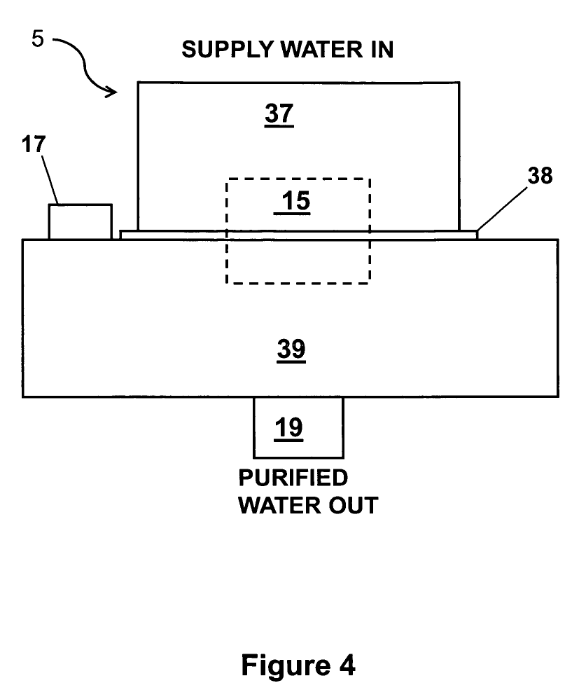

FIG. 4 is a schematic view of another exemplary embodiment that uses gravity to control the static pressure in the purified water storage reservoir.

Referring now to FIG. 4, water from any available source is transported by any suitable means and poured into an upper water reservoir 37 that is open to the atmosphere at the top. An ultrafiltration (UF) filter housing 15, which contains a replaceable dead-end UF cartridge with a membrane pore size range or 0.01-0.05 microns and any necessary pretreatment media, is installed in the bottom of upper reservoir 37 and continues into and through the top of lower reservoir 39. Purified water exits housing 15 directly into a lower water reservoir 39 due to the force of gravity. Upper reservoir 37 containing the ultrafiltration filter housing 15 is installed on top of lower reservoir 39 and connected to lower reservoir by means of an airtight seal 38. The ultrafiltration filter housing 15 extends into lower reservoir 39 through airtight seal 38 such that purified water enters the lower reservoir 39 without allowing any air to enter lower reservoir 39. A bi-directional hydrophobic membrane vent filter assembly 17, which contains replaceable bi-directional hydrophobic flat membranes discs—(not shown), is installed at the top of the lower reservoir 39 through a suitable airtight connection in the top of lower reservoir 39. Purified water can be dispensed directly from the lower reservoir 39 by a suitable spigot or dispensing valve 19.

Alternatively, the lower reservoir 39 can be installed in or made a part of dispensing system for example a water cooler, among others, in a sealed relationship. Alternatively upper water reservoir 37 can be constructed as a collapsible cylinder so that the height of upper reservoir 37 can be reduced once the untreated water has drained into lower reservoir 39 after being purified. The replaceable ultrafiltration cartridge (not shown) can also be a combination cartridge with particulate filter media, carbon filter media and other filter media in addition to the UF membrane components, and the bi-directional hydrophobic vent membrane can be supplied as a pleated membrane or a hollow fiber membrane.

Referring again to FIG. 4, in an exemplary embodiment, the height of the upper reservoir 37 containing untreated water is a pressure-regulating device, thereby the upper reservoir itself can act as a pressure regulating device. The pressure exerted by a column of water in an open container is a function of its height. A column of water measuring 27.68 inches high will exert a pressure of one (1) pound per square inch (PSI). Using an upper reservoir 37 of less than 10 feet in height will limit the pressure on the UF filter housing 15 and the lower reservoir 39 to less than 5 PSI. Since practically sized upper reservoirs will range from 2 to 4 feet in height, the static container pressures developed by this gravity flow system will be well below 5-PSI and will not risk creating leaks or ruptures of the lower reservoir 39. As purified water is withdrawn from lower reservoir 39, the height of the water column in upper reservoir 37 steadily declines, as does the pressure exerted on UF filter housing 15. When upper reservoir 37 is nearly empty, the flow through the UF filter housing 15 stops as the pressure exerted by gravity diminishes to virtually zero.

Referring again to FIG. 4, in an exemplary embodiment, once the hydrophilic UF membranes in UF filter housing 15 are wetted during the first use, these membranes will no longer pass air. As water is withdrawn from lower reservoir 39 at any rate faster than the flow from the UF filter housing 15, air will enter the lower reservoir 39 by means of the bi-directional hydrophobic membrane vent filter assembly 17. When the lower reservoir 39 is being refilled by UF filter housing 15, air exits the lower reservoir 39 through the bi-directional hydrophobic membrane vent filter assembly 17; and lower reservoir 39 is never exposed to air that potentially contains bacteria or viruses. In addition, the upper reservoir 37 cannot overfill lower reservoir 39 since the bi-directional hydrophobic membrane vent filter assembly 17 will block water at the static pressure exerted by gravity from upper reservoir 37. Since the static pressure from upper reservoir will be well below 5 PSI for upper reservoir 37 heights below 10 feet, water will not leak from lower reservoir 39 and once lower reservoir 39 is full, the back-pressure on the UF filter housing 15 stops the flow of purified water.

The advantages of these devices compared to other purifier systems are their low cost and self-regulating operation. In exemplary embodiments, they combine widely available low cost plastic bottles and other plastic containers with inexpensive bi-directional hydrophobic membrane vent filters. The modified bottles and containers are easily installed in any type of water cooler or dispenser. Purifier water is supplied to these containers at low pressure from a suitable UF filter, and when the bottle or container is full, the flow stops. And when the UF filter has reached the end of its useful life due to accumulated contamination, the flow also stops to signal the user to replace the UF filter. The use of low pressure also helps to extend the life of the UF filter. At low pressures, accumulated contaminates will not block the membrane filter's pores as extensively as do blockages that occur at higher pressures. The use of a dead end hollow fiber membrane UF filter also allows the device to operate without a drain and therefore, does not waste water.

While exemplary embodiments have been shown and described, various modifications and substitutions may be made thereto without departing from the spirit and scope of the invention. Accordingly, it is to be understood that the present invention has been described by way of illustration and not limitation.

What is claimed is:

1. A water purification system, comprising:
a pressure regulating device configured to output water at a pressure substantially between 1 and 8 pounds per square inch;
a filter housing coupled to the pressure regulating device;
a storage reservoir coupled to the pressure regulating device, and configured to receive water from the filter housing; and
a vent filter disposed substantially in operational communication with the storage reservoir.

2. The water purification system according to claim 1, wherein the vent filter comprises at least one bi-directional hydrophobic membrane.

3. The water purification system according to claim 1, wherein the vent filter is configured to pass air into and out of the storage reservoir.

4. The water purification system according to claim 1, wherein the vent filter has a pore size substantially between 0.01 and 0.05 microns.

5. The water purification system according to claim 1, wherein the filter housing is configured to receive a filter element.

6. The water purification system according to claim 5, wherein the filter element is an ultrafiltration membrane filter.

7. The water purification system according to claim 6, wherein the ultrafiltration membrane filter pore size is substantially between 0.01 and 0.05 microns.

8. The water purification system according to claim 6, wherein the ultrafiltration membrane filter comprises a hydrophilic capillary microfiltration tubular membrane.

9. The water purification system according to claim 5, wherein the filter element is configured to remove particles larger than 0.15 microns from water.

10. The water purification system according to claim 1, further comprising a water supply inlet configured to detachably receive a water supply line.

11. The water purification system according to claim 1, wherein the storage reservoir is detachably coupled to the pressure regulating device.

12. The water purification system according to claim 1, wherein the pressure regulating device comprises a water pressure regulator.

13. The water purification system according to claim 1, wherein the pressure regulating device comprises a water storage container comprising a first opening and a second opening, wherein the second opening is configured to direct a flow of water through the filter housing to the storage reservoir.

14. The water purification system according to claim 1, wherein the vent filter is disposed substantially within an aperture of the storage reservoir.

15. A method, comprising:
providing a pressure regulating device configured to output water at a pressure substantially between 1 and 8 pounds per square inch,
providing a filter housing configured to couple to the pressure regulating device,
providing a storage reservoir configured to couple to the pressure regulating device, and configured to receive water from the filter housing, and
providing a vent filter disposed substantially in operational communication with the storage reservoir.

16. The method according to claim 15, wherein the vent filter comprises at least one bi-directional hydrophobic membrane.

17. The method according to claim 15, wherein the vent filter is configured to pass air into and out of the storage reservoir.

18. The method according to claim 15, wherein the vent filter has a pore size substantially between 0.01 and 0.05 microns.

19. A method, comprising:
connecting a storage reservoir comprising a vent filter to an assembly comprising an ultrafiltration filter element, and
providing an amount of water from a water supply source through the ultrafiltration filter element for deposition into the storage reservoir.

20. The method according to claim 19, further comprising depositing the amount of water into the storage reservoir from the ultrafiltration filter element.

21. The method according to claim 19, wherein the vent filter comprises at least one bi-directional hydrophobic membrane.

22. The method according to claim 19, wherein the vent filter is configured to pass air into and out of the storage reservoir.

23. The method according to claim 19, wherein the vent filter has a pore size substantially between 0.01 and 0.05 microns.

24. A water purification system, comprising:
means for outputting water at a pressure substantially between 1 and 8 pounds per square inch;
means for housing a filter element, wherein the means for housing are coupled to the means for outputting water;
means for storing an amount of water, wherein the means for storing are coupled to the means for outputting water; and
means for filtering air vented into and out of the means for storing.

25. A water purification system, comprising:
a first pressure regulating device configured to output water at a pressure substantially between 10 and 20 pounds per square inch,
a second pressure regulating device configured to output water at a pressure substantially between 1 and 8 pounds per square inch;
at least one filtration element positioned between the first pressure regulating device and the second pressure regulating device;
an ultrafiltration membrane filter positioned between the first pressure regulating device and the second pressure regulating device;
a storage reservoir coupled to the second pressure regulating device, and configured to receive water output by at least the second pressure regulating device; and
a bi-directional hydrophobic membrane vent filter disposed substantially within an opening of the storage reservoir.
